(19) United States
(12) Patent Application Publication
(10) Pub. No.: US 2015/0095475 A1
(43) Pub. Date: Apr. 2, 2015

(54) ONLINE CONTENT EXTENSIONS USED FOR SCHEDULING COMMUNICATIONS WITH THE CONTENT PROVIDER

(71) Applicant: Google Inc., Mountain View, CA (US)

(72) Inventors: Lakshmi Kumar Dabbiru, Sunnyvale, CA (US); Tengfei Mu, Mountain View, CA (US)

(73) Assignee: Google Inc., Mountain View, CA (US)

(21) Appl. No.: 14/039,950

(22) Filed: Sep. 27, 2013

(51) Int. Cl. H04L 29/08

(52) U.S. Cl. CPC H04L 67/325
USPC 709/223

(57) ABSTRACT

An online content server for scheduling a communication between a content provider and a customer includes a memory device for storing data. The online content server also includes a processor in communication with the memory device. The processor is programmed to receive at the processor at least one content provider availability period associated with at least one online content, receive at the processor at least one customer availability period from a customer computing device, determine at least one communication schedule option based upon the content provider availability period and the customer availability period, transmit the at least one communication schedule option to the customer computing device along with the online content, receive a communication selection from the customer computing device, and transmit the communication selection to the content provider.

### BACKGROUND

This description relates to scheduling a communication between a content provider and a customer, and more particularly, to online extensions used for scheduling communications between a customer and a content provider.

Most online content, including online advertisements, is associated with an online content provider, including online advertisers. At least some online content providers have representatives including, for example, customer service representatives available to discuss goods, services, and other offerings related to the online content provider. At least some representatives are available for telephonic communication using telephone numbers.

Some users, including customers, may wish to communicate with representatives of the online content providers using telephonic communication. Although some known systems facilitate instantaneous communication between a user and an online content provider representative, it may be difficult to identify times for communication between users and online content provider representatives without scheduling difficulties including wait times.

### BRIEF DESCRIPTION OF THE DISCLOSURE

In one aspect, a computer-implemented method for scheduling a communication between a content provider and a customer is provided. The method is implemented by an online content server coupled to a memory device. The method includes receiving at the online content server at least one content provider availability period associated with at least one online content, receiving at the online content server at least one customer availability period from a customer computing device, determining at least one communication schedule option based upon the content provider availability period and the customer availability period, transmitting the at least one communication schedule option to the customer computing device along with the online content, receiving a communication selection from the customer computing device, and transmitting the communication selection to the content provider.

In another aspect, an online content server for scheduling a communication between a content provider and a customer is provided. The online content server includes a memory device for storing data. The online content server also includes a processor in communication with the memory device. The processor is programmed to receive at the processor at least one content provider availability period associated with at least one online content, receive at the processor at least one customer availability period from a customer computing device, determine at least one communication schedule option based upon the content provider availability period and the customer availability period, transmit the at least one communication schedule option to the customer computing device along with the online content, receive a communication selection from the customer computing device, and transmit the communication selection to the content provider.

In another aspect, a computer-readable storage device having processor-executable instructions embodied thereon, for scheduling a communication between a content provider and a customer is provided. When executed by a computing device, the processor-executable instructions cause the computing device to receive at the processor at least one content provider availability period associated with at least one online content, receive at the processor at least one customer availability period from a customer computing device, determine at least one communication schedule option based upon the content provider availability period and the customer availability period, transmit the at least one communication schedule option to the customer computing device along with the online content, receive a communication selection from the customer computing device, and transmit the communication selection to the content provider.

In another aspect, a system for scheduling a communication between a content provider and a customer is provided. The system includes means for receiving at the online content server at least one content provider availability period associated with at least one online content, means for receiving at the online content server at least one customer availability period from a customer computing device, means for determining at least one communication schedule option based upon the content provider availability period and the customer availability period, means for transmitting the at least one communication schedule option to the customer computing device along with the online content, means for receiving a communication selection from the customer computing device, and means for transmitting the communication selection to the content provider.

In another aspect, the system described above is provided, wherein the system further includes means for receiving at least one of call volumes associated with a plurality of time intervals, non-operational time intervals, and call durations associated with a plurality of time intervals.

In another aspect, the system described above is provided, wherein the system further includes means for receiving a list of time intervals when the content provider is available for communication.

In another aspect, the system described above is provided, wherein the system further includes means for receiving a contact identifier for a customer wherein the contact identifier includes at least one telephone number.

In another aspect, the system described above is provided, wherein the system further includes means for receiving a schedule from a customer from a scheduling software stored on at least one of the customer computing device, the online content server, and a scheduling server.

In another aspect, the system described above is provided, wherein the system further includes means for automatically initiating a call between the customer and the content provider during the time period associated with the communication selection using an automated phone system.

In another aspect, the system described above is provided, wherein the system further includes means for determining, from the at least one communication schedule option, a preferred schedule option based upon at least one of a customer preference and a content provider preference and means for transmitting the at least one communication schedule option to the customer computing device wherein the preferred schedule option is displayed as a preferred option.

In another aspect, the system described above is provided, wherein the system further includes means for receiving a customer interaction associated with the online content presented to the customer.

In another aspect, the system described above is provided, wherein the system further includes means for creating a callback extension associated with the online content, wherein the callback extension represents a customer module configured to receive customer interaction to associated with the communication selection and means for displaying the callback extension with the online content.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a diagram depicting an example advertising environment;

FIG. 2 is a block diagram of a computing device, used for scheduling a communication between a content provider and a customer, as shown in the advertising environment of FIG. 1;

FIG. 3 is an example process flowchart of scheduling a communication between a content provider and a customer using the computing device of FIG. 2 in the advertising environment shown in FIG. 1;

FIG. 4 is an example process flowchart of providing an online content configured to be used in scheduling a communication between a content provider and a customer using computing device of FIG. 2 in the advertising environment shown in FIG. 1;

FIG. 5A is an example computing device displaying a first online content configured to schedule a communication between a content provider and a customer, using computing device of FIG. 2 in the advertising environment shown in FIG. 1;

FIG. 5B is an example computing device displaying a second online content configured to schedule a communication between a content provider and a customer, using computing device of FIG. 2 in the advertising environment shown in FIG. 1;

FIG. 5C is an example computing device displaying a third online content configured to schedule a communication between a content provider and a customer, using computing device of FIG. 2 in the advertising environment shown in FIG. 1;

FIG. 5D is an example computing device displaying a fourth online content configured to schedule a communication between a content provider and a customer, using computing device of FIG. 2 in the advertising environment shown in FIG. 1;

FIG. 5E is an example computing device displaying a fifth online content configured to schedule a communication between a content provider and a customer, using computing device of FIG. 2 in the advertising environment shown in FIG. 1;

FIG. 6 is an example method for scheduling a communication between a content provider and a customer using the advertising environment of FIG. 1; and

FIG. 7 is a diagram of components of one or more example computing devices that may be used in the environment shown in FIG. 1.

Although specific features of various embodiments may be shown in some drawings and not in others, this is for convenience only. Any feature of any drawing may be referenced and/or claimed in combination with any feature of any other drawing.

### DETAILED DESCRIPTION OF THE DISCLOSURE

The following detailed description of implementations refers to the accompanying drawings. The same reference numbers in different drawings may identify the same or similar elements. Also, the following detailed description does not limit the claims.

This subject matter described herein relates generally to scheduling a communication between a content provider, such as an online advertiser, and a potential customer of the online advertiser (“user”). Specifically, the methods and systems described herein enable the receiving of at least one content provider availability period associated with at least one online content and of at least one customer availability period from a customer computing device, the determining of at least one communication schedule option based upon the content provider availability period and the customer availability period, the transmitting of at least one communication schedule option to the customer computing device along with the online content, the receiving of a communication selection from the customer computing device, and the transmitting of the communication selection to the content provider.

At least one content provider availability is received by an online content server from a computer device associated with a content provider. The content provider availability is associated with at least one online content including, for example, at least one online advertisement. The content provider availability represents at least one time period when the content provider is available for a communication with a customer including, for example, a user. The communication may be conducted using a telephone or, alternately, a chat service such as a voice chat service. The content provider availability may include, for example, a list of time intervals when the content provider is available for communication.

The online content server may additionally receive, from the computer device associated with the content provider, call volumes associated with a plurality of time intervals, non-operational time intervals, and call durations associated with a plurality of time intervals. Such information may be beneficial in determining preferable times for communication with the content provider.

At least one customer availability period is also received by the online content server from a customer computing device associated with a customer. The customer availability period represents at least one time period when the customer is available for communication with the content provider. The customer availability period may include, for example, a list of time intervals when the customer is available for communication. The customer availability period may be received from a scheduling software including, for example, an online scheduling tool, a file or program at the customer computing device, or scheduling services associated with the customer on the online content server. Along with the customer availability period, a customer contact identifier is received by the online content server from the customer computing device. The customer contact identifier includes at least one of a telephone number and an identifier for a voice chat service.

Using the content provider availability period and the customer availability period, along with other information such as content provider data (e.g., call volumes associated with a plurality of time intervals, non-operational time intervals, and call durations associated with a plurality of time intervals) and customer data (e.g., customer schedule data and customer preferences), the online content server determines at least one communication schedule option. The at least one communication schedule option represents at least one time interval when communication may be made between a customer and a content provider, considering the respective restrictions in the schedules of each. In cases where multiple communication schedule options are determined, the online content server may additionally determine a preferred schedule option based upon at least one of a customer preference and a content provider preference. The customer preference and the content provider preference may be reflected in the content provider data and the customer data.

The at least one communication schedule option is transmitted by the online content server to the customer computing device along with the online content. In other words, online content such as an online advertisement is presented with the communication schedule options so that a customer can view time intervals when communication with the content provider may be scheduled. The customer may then select a particular time interval in order to schedule such communication. If the online content server determines a preferred schedule option, the online content server may additionally transmit the preferred schedule option and display the preferred schedule option with an indication such as highlighting, textual indicators, and graphical indicators. The online content server additionally creates a callback extension associated with the online content to display the communication schedule options. The call back extension is a customer module configured to receive customer interaction to associated with the communication selection.

The online content server receives a communication selection from the customer computing device. The communication selection represents the selection of a time interval by the customer from the communication schedule options. In other words, the customer selects a particular time interval to communicate with the content provider and the selection is transmitted to the online content server. The customer makes the communication selection by interacting with the online content presented to the customer including, for example, clicking on a particular time interval in a schedule.

The online content server transmits the communication selection to the computing device associated with the content provider. This allows the content provider to schedule the communication and ultimately communicate with the customer. The online content server also receives an acknowledgement from the content provider indicating that the content provider can facilitate the call as scheduled. The online content server transmits a confirmation to the customer computing device indicating that the call has been successfully scheduled. The communication can additionally be facilitated using an automated system. The call or communication between the customer and the content provider may be automatically initiated using such an automated system at the time represented by the communication selection.

As used herein, an element or step recited in the singular and proceeded with the word “a” or “an” should be understood as not excluding plural elements or steps, unless such exclusion is explicitly recited. Furthermore, references to “one embodiment” of the subject matter disclosed herein are not intended to be interpreted as excluding the existence of additional embodiments that also incorporate the recited features.

The methods and systems described herein may be implemented using computer programming or engineering techniques including computer software, firmware, hardware or any combination or subset thereof, wherein the technical effects may be achieved by performing one of the following steps: (a) receiving, at the online content server, at least one content provider availability period associated with at least one online content; (b) receiving, at the online content server, at least one customer availability period from a customer computing device; (c) determining, based upon the content provider availability period and the customer availability period, at least one communication schedule option; (d) transmitting the at least one communication schedule option to the customer computing device along with the online content; (e) receiving a communication selection from the customer computing device; (f) transmitting the communication selection to the content provider; (g) receiving an acknowledgement from the content provider; (h) transmitting a confirmation to the customer computing device (i) receiving at least one of call volumes associated with a plurality of time intervals, non-operational time intervals, and call durations associated with a plurality of time intervals; (j) receiving a list of time intervals when the content provider is available for communication; (k) receiving a contact identifier for a customer wherein the contact identifier includes at least one telephone number; (l) receiving a schedule from a customer from a scheduling software stored on at least one of the customer computing device, the online content server, and a scheduling server; (m) automatically initiating a call between the customer and the content provider during the time period associated with the communication selection using an automated phone system; (n) determining, from the at least one communication schedule option, a preferred schedule option based upon at least one of a customer preference and a content provider preference; (o) transmitting the at least one communication schedule option to the customer computing device wherein the preferred schedule option is displayed as a preferred option; (p) receiving a customer interaction associated with the online content items presented to the customer; (q) creating a callback extension associated with the online content, wherein the callback extension represents a customer module configured to receive customer interaction to associated with the communication selection and displaying the callback extension with the online content.

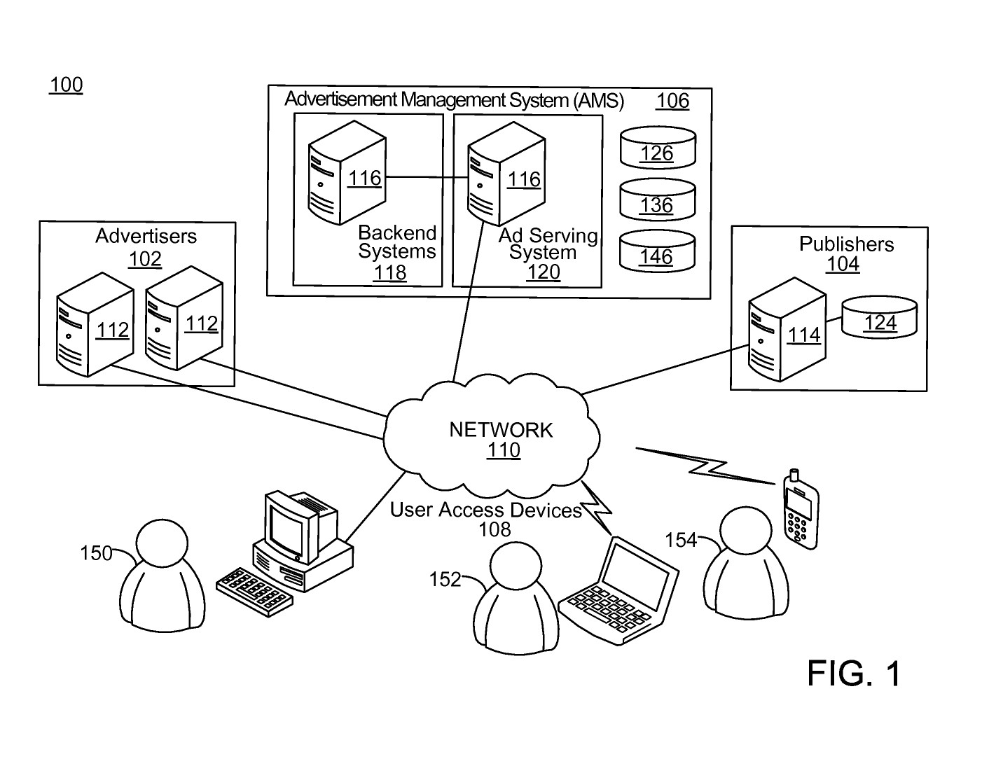

FIG. 1 is a diagram depicting an example online content environment 100. Online content environment 100 may be used in the context of serving online advertisements to a user, including a user of a mobile computing device, in combination with online publications. With reference to FIG. 1, example environment 100 may include one or more advertisers 102 (i.e., online content providers), one or more publishers 104, an advertisement management system (AMS) 106, and one or more user access devices 108, which may be coupled to a network 110. User access devices are used by users 150, 152, and 154. Each of the elements 102, 104, 106, 108 and 110 in FIG. 1 may be implemented or associated with hardware components, software components, or firmware components or any combination of such components. The elements 102, 104, 106, 108 and 110 can, for example, be implemented or associated with general purpose servers, software processes and engines, and/or various embedded systems. The elements 102, 104, 106 and 110 may serve, for example, as an advertisement distribution network. While reference is made to distributing advertisements, the environment 100 can be suitable for distributing other forms of content including other forms of sponsored content. AMS 106 may also be referred to as a content management system 106.

The advertisers 102 may include any entities that are associated with advertisements (“ads”). An advertisement or an “ad” refers to any form of communication in which one or more products, services, ideas, messages, people, organizations or other items are identified and promoted (or otherwise communicated). Ads are not limited to commercial promotions or other communications. An ad may be a public service announcement or any other type of notice, such as a public notice published in printed or electronic press or a broadcast. An ad may be referred to as sponsored content.

Ads may be communicated via various mediums and in various forms. In some examples, ads may be communicated through an interactive medium, such as the Internet, and may include graphical ads (e.g., banner ads), textual ads, image ads, audio ads, video ads, ads combining one of more of any of such components, or any form of electronically delivered advertisement. Ads may include embedded information, such as embedded media, links, meta-information, and/or machine executable instructions. Ads could also be communicated through RSS (Really Simple Syndication) feeds, radio channels, television channels, print media, and other media.

The term “ad” can refer to both a single “creative” and an “ad group.” A creative refers to any entity that represents one ad impression. An ad impression refers to any form of presentation of an ad such that it is viewable/receivable by a user. In some examples, an ad impression may occur when an ad is displayed on a display device of a user access device. An ad group refers, for example, to an entity that represents a group of creatives that share a common characteristic, such as having the same ad selection and recommendation criteria. Ad groups can be used to create an ad campaign.

The advertisers 102 may provide (or be otherwise associated with) products and/or services related to ads. The advertisers 102 may include or be associated with, for example, retailers, wholesalers, warehouses, manufacturers, distributors, health care providers, educational establishments, financial establishments, technology providers, energy providers, utility providers, or any other product or service providers or distributors.

The advertisers 102 may directly or indirectly generate, and/or maintain ads, which may be related to products or services offered by or otherwise associated with the advertisers. The advertisers 102 may include or maintain one or more data processing systems 112, such as servers or embedded systems, coupled to the network 110. The advertisers 102 may include or maintain one or more processes that run on one or more data processing systems.

The publishers 104 may include any entities that generate, maintain, provide, present and/or otherwise process content in the environment 100. “Publishers,” in particular, include authors of content, wherein authors may be individual persons, or, in the case of works made for hire, the proprietor(s) who hired the individual(s) responsible for creating the online content. The term “content” refers to various types of web-based, software application-based and/or otherwise presented information, including articles, discussion threads, reports, analyses, financial statements, music, video, graphics, search results, web page listings, information feeds (e.g., RSS feeds), television broadcasts, radio broadcasts, printed publications, or any other form of information that may be presented to a user using a computing device such as one of user access devices 108.

In some implementations, the publishers 104 may include content providers with an Internet presence, such as online publication and news providers (e.g., online newspapers, online magazines, television websites, etc.), online service providers (e.g., financial service providers, health service providers, etc.), and the like. The publishers 104 can include software application providers, television broadcasters, radio broadcasters, satellite broadcasters, and other content providers. One or more of the publishers 104 may represent a content network that is associated with the AMS 106.

The publishers 104 may receive requests from the user access devices 108 (or other elements in the environment 100) and provide or present content to the requesting devices. The publishers may provide or present content via various mediums and in various forms, including web based and non-web based mediums and forms. The publishers 104 may generate and/or maintain such content and/or retrieve the content from other network resources.

In addition to content, the publishers 104 may be configured to integrate or combine retrieved content with additional sets of content, for example ads, that are related or relevant to the retrieved content for display to users 150, 152, and 154. As discussed further below, these relevant ads may be provided from the AMS 106 and may be combined with content for display to users 150, 152, and 154. In some examples, the publishers 104 may retrieve content for display on a particular user access device 108 and then forward the content to the user access device 108 along with code that causes one or more ads from the AMS 106 to be displayed to the user 150, 152, or 154. As used herein, user access devices 108 may also be known as customer computing devices 108. In other examples, the publishers 104 may retrieve content, retrieve one or more relevant ads (e.g., from the AMS 106 or the advertisers 102), and then integrate the ads and the article to form a content page for display to the user 150, 152, or 154.

As noted above, one or more of the publishers 104 may represent a content network. In such an implementation, the advertisers 102 may be able to present ads to users through this content network.

The publishers 104 may include or maintain one or more data processing systems 114, such as servers or embedded systems, coupled to the network 110. They may include or maintain one or more processes that run on data processing systems. In some examples, the publishers 104 may include one or more content repositories 124 for storing content and other information.

The AMS 106 manages ads and provides various services to the advertisers 102, the publishers 104, and the user access devices 108. The AMS 106 may store ads in an ad repository 126 and facilitate the distribution or selective provision and recommendation of ads through the environment 100 to the user access devices 108. In some configurations, the AMS 106 may include or access functionality associated with managing online content and/or online advertisements, particularly functionality associated with serving online content and/or online advertisements to mobile computing devices.

The AMS 106 may include one or more data processing systems 116, such as servers or embedded systems, coupled to the network 110. It can also include one or more processes, such as server processes. In some examples, the AMS 106 may include an ad serving system 120 and one or more backend processing systems 118. The ad serving system 120 may include one or more data processing systems 116 and may perform functionality associated with delivering ads to publishers or user access devices 108. The backend processing systems 118 may include one or more data processing systems 116 and may perform functionality associated with identifying relevant ads to deliver, processing various rules, performing filtering processes, generating reports, maintaining accounts and usage information, and other backend system processing. The AMS 106 can use the backend processing systems 118 and the ad serving system 120 to selectively recommend and provide relevant ads from the advertisers 102 through the publishers 104 to the user access devices 108.

The AMS 106 may include or access one or more crawling, indexing and searching modules (not shown). These modules may browse accessible resources (e.g., the World Wide Web, publisher content, data feeds, etc.) to identify, index and store information. The modules may browse information and create copies of the browsed information for subsequent processing. The modules may also check links, validate code, harvest information, and/or perform other maintenance or other tasks.

Searching modules may search information from various resources, such as the World Wide Web, publisher content, intranets, newsgroups, databases, and/or directories. The search modules may employ one or more known search or other processes to search data. In some implementations, the search modules may index crawled content and/or content received from data feeds to build one or more search indices. The search indices may be used to facilitate rapid retrieval of information relevant to a search query.

The AMS 106 may include one or more interface or frontend modules for providing the various features to advertisers, publishers, and user access devices. For example, the AMS 106 may provide one or more publisher front-end interfaces (PFEs) for allowing publishers to interact with the AMS 106. The AMS 106 may also provide one or more advertiser front-end interfaces (AFEs) for allowing advertisers to interact with the AMS 106. In some examples, the front-end interfaces may be configured as web applications that provide users with network access to features available in the AMS 106.

The AMS 106 provides various advertising management features to the advertisers 102. The AMS 106 advertising features may allow users to set up user accounts, set account preferences, create ads, select keywords for ads, create campaigns or initiatives for multiple products or businesses, view reports associated with accounts, analyze costs and return on investment, selectively identify customers in different regions, selectively recommend and provide ads to particular publishers, analyze financial information, analyze ad performance, estimate ad traffic, access keyword tools, add graphics and animations to ads, etc.

The AMS 106 may allow the advertisers 102 to create ads and input keywords or other ad placement descriptors for which those ads will appear. In some examples, the AMS 106 may provide ads to user access devices or publishers when keywords associated with those ads are included in a user request or requested content. The AMS 106 may also allow the advertisers 102 to set bids for ads. A bid may represent the maximum amount an advertiser is willing to pay for each ad impression, user click-through of an ad or other interaction with an ad. A click-through can include any action a user takes to select an ad. Other actions include haptic feedback or gyroscopic feedback to generate a click-through. The advertisers 102 may also choose a currency and monthly budget.

The AMS 106 may also allow the advertisers 102 to view information about ad impressions, which may be maintained by the AMS 106. The AMS 106 may be configured to determine and maintain the number of ad impressions relative to a particular website or keyword. The AMS 106 may also determine and maintain the number of click-throughs for an ad as well as the ratio of click-throughs to impressions.

The AMS 106 may also allow the advertisers 102 to select and/or create conversion types for ads. A “conversion” may occur when a user consummates a transaction related to a given ad. A conversion could be defined to occur when a user clicks, directly or implicitly (e.g., through haptic or gyroscopic feedback), on an ad, is referred to the advertiser's web page, and consummates a purchase there before leaving that web page. In another example, a conversion could be defined as the display of an ad to a user and a corresponding purchase on the advertiser's web page within a predetermined time (e.g., seven days). The AMS 106 may store conversion data and other information in a conversion data repository 136.

The AMS 106 may allow the advertisers 102 to input description information associated with ads. This information could be used to assist the publishers 104 in determining ads to publish. The advertisers 102 may additionally input a cost/value associated with selected conversion types, such as a five dollar credit to the publishers 104 for each product or service purchased.

The AMS 106 may provide various features to the publishers 104. The AMS 106 may deliver ads (associated with the advertisers 102) to the user access devices 108 when users access content from the publishers 104. The AMS 106 can be configured to deliver ads that are relevant to publisher sites, site content, and publisher audiences.

In some examples, the AMS 106 may crawl content provided by the publishers 104 and deliver ads that are relevant to publisher sites, site content and publisher audiences based on the crawled content. The AMS 106 may also selectively recommend and/or provide ads based on user information and behavior, such as particular search queries performed on a search engine website, or a designation of an ad for subsequent review, as described herein, etc. The AMS 106 may store user-related information in a general database 146. In some examples, the AMS 106 can add search services to a publisher site and deliver ads configured to provide appropriate and relevant content relative to search results generated by requests from visitors of the publisher site. A combination of these and other approaches can be used to deliver relevant ads.

The AMS 106 may allow the publishers 104 to search and select specific products and services as well as associated ads to be displayed with content provided by the publishers 104. For example, the publishers 104 may search through ads in the ad repository 126 and select certain ads for display with their content.

The AMS 106 may be configured to selectively recommend and provide ads created by the advertisers 102 to the user access devices 108 directly or through the publishers 104. The AMS 106 may selectively recommend and provide ads to a particular publisher 104 (as described in further detail herein) or a requesting user access device 108 when a user requests search results or loads content from the publisher 104.

In some implementations, the AMS 106 may manage and process financial transactions among and between elements in the environment 100. For example, the AMS 106 may credit accounts associated with the publishers 104 and debit accounts of the advertisers 102. These and other transactions may be based on conversion data, impressions information and/or click-through rates received and maintained by the AMS 106.

“Computing devices”, for example user access devices 108, may include any devices capable of receiving information from the network 110. The user access devices 108 could include general computing components and/or embedded systems optimized with specific components for performing specific tasks. Examples of user access devices include personal computers (e.g., desktop computers), mobile computing devices, cell phones, smart phones, head-mounted computing devices, media players/recorders, music players, game consoles, media centers, media players, electronic tablets, personal digital assistants (PDAs), television systems, audio systems, radio systems, removable storage devices, navigation systems, set top boxes, other electronic devices and the like. The user access devices 108 can also include various other elements, such as processes running on various machines.

The network 110 may include any element or system that facilitates communications among and between various network nodes, such as elements 108, 112, 114 and 116. The network 110 may include one or more telecommunications networks, such as computer networks, telephone or other communications networks, the Internet, etc. The network 110 may include a shared, public, or private data network encompassing a wide area (e.g., WAN) or local area (e.g., LAN). In some implementations, the network 110 may facilitate data exchange by way of packet switching using the Internet Protocol (IP). The network 110 may facilitate wired and/or wireless connectivity and communication.

For purposes of explanation only, certain aspects of this disclosure are described with reference to the discrete elements illustrated in FIG. 1. The number, identity and arrangement of elements in the environment 100 are not limited to what is shown. For example, the environment 100 can include any number of geographically-dispersed advertisers 102, publishers 104 and/or user access devices 108, which may be discrete, integrated modules or distributed systems. Similarly, the environment 100 is not limited to a single AMS 106 and may include any number of integrated or distributed AMS systems or elements.

Furthermore, additional and/or different elements not shown may be contained in or coupled to the elements shown in FIG. 1, and/or certain illustrated elements may be absent. In some examples, the functions provided by the illustrated elements could be performed by less than the illustrated number of components or even by a single element. The illustrated elements could be implemented as individual processes running on separate machines or a single process running on a single machine.

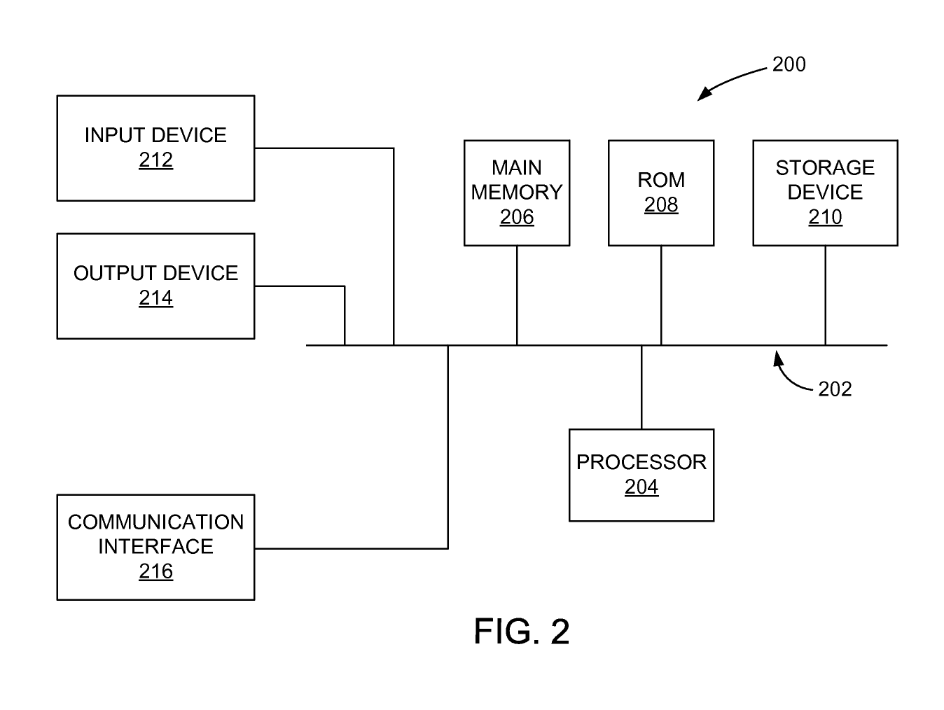

FIG. 2 is a block diagram of a computing device 200 used for automatically delivering dynamic online content to a mobile computing device, as shown in advertising environment 100 (shown in FIG. 1).

FIG. 2 shows an example of a generic computing device 200 intended to represent various forms of digital computers, such as laptops, desktops, workstations, personal digital assistants, servers, blade servers, mainframes, and other appropriate computers. Computing device 200 is also intended to represent various forms of mobile devices, such as personal digital assistants, cellular telephones, smart phones, and other similar computing devices. The components shown here, their connections and relationships, and their functions, are meant to be examples only, and are not meant to limit implementations of the subject matter described and/or claimed in this document.

In the example embodiment, computing device 200 could be user access device 108 or any of data processing devices 112, 114, or 116 (shown in FIG. 1). Computing device 200 may include a bus 202, a processor 204, a main memory 206, a read only memory (ROM) 208, a storage device 210, an input device 212, an output device 214, and a communication interface 216. Bus 202 may include a path that permits communication among the components of computing device 200.

Processor 204 may include any type of conventional processor, microprocessor, or processing logic that interprets and executes instructions. Processor 204 can process instructions for execution within the computing device 200, including instructions stored in the memory 206 or on the storage device 210 to display graphical information for a GUI on an external input/output device, such as display 214 coupled to a high speed interface. In other implementations, multiple processors and/or multiple buses may be used, as appropriate, along with multiple memories and types of memory. Also, multiple computing devices 200 may be connected, with each device providing portions of the necessary operations (e.g., as a server bank, a group of blade servers, or a multi-processor system).

Main memory 206 may include a random access memory (RAM) or another type of dynamic storage device that stores information and instructions for execution by processor 204. ROM 208 may include a conventional ROM device or another type of static storage device that stores static information and instructions for use by processor 204. Main memory 206 stores information within the computing device 200. In one implementation, main memory 206 is a volatile memory unit or units. In another implementation, main memory 206 is a non-volatile memory unit or units. Main memory 206 may also be another form of computer-readable medium, such as a magnetic or optical disk.

Storage device 210 may include a magnetic and/or optical recording medium and its corresponding drive. The storage device 210 is capable of providing mass storage for the computing device 200. In one implementation, the storage device 210 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as main memory 206, ROM 208, the storage device 210, or memory on processor 204.

The high speed controller manages bandwidth-intensive operations for the computing device 200, while the low speed controller manages lower bandwidth-intensive operations. Such allocation of functions is for purposes of example only. In one implementation, the high-speed controller is coupled to main memory 206, display 214 (e.g., through a graphics processor or accelerator), and to high-speed expansion ports, which may accept various expansion cards (not shown). In the implementation, low-speed controller is coupled to storage device 210 and low-speed expansion port. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Input device 212 may include a conventional mechanism that permits computing device 200 to receive commands, instructions, or other inputs from a user 150, 152, or 154, including visual, audio, touch, button presses, stylus taps, etc. Additionally, input device may receive location information. Accordingly, input device 212 may include, for example, a camera, a microphone, one or more buttons, a touch screen, and/or a GPS receiver. Output device 214 may include a conventional mechanism that outputs information to the user, including a display (including a touch screen) and/or a speaker. Communication interface 216 may include any transceiver-like mechanism that enables computing device 200 to communicate with other devices and/or systems. For example, communication interface 216 may include mechanisms for communicating with another device or system via a network, such as network 110 (shown in FIG. 1).

As described herein, computing device 200 facilitates the presentation of content from one or more publishers, along with one or more sets of sponsored content, for example ads, to a user. Computing device 200 may perform these and other operations in response to processor 204 executing software instructions contained in a computer-readable medium, such as memory 206. A computer-readable medium may be defined as a physical or logical memory device and/or carrier wave. The software instructions may be read into memory 206 from another computer-readable medium, such as data storage device 210, or from another device via communication interface 216. The software instructions contained in memory 206 may cause processor 204 to perform processes described herein. Alternatively, hardwired circuitry may be used in place of or in combination with software instructions to implement processes consistent with the subject matter herein. Thus, implementations consistent with the principles of the subject matter disclosed herein are not limited to any specific combination of hardware circuitry and software.

The computing device 200 may be implemented in a number of different forms, as shown in the figure. For example, it may be implemented as a standard server, or multiple times in a group of such servers. It may also be implemented as part of a rack server system. In addition, it may be implemented in a personal computer such as a laptop computer. Each of such devices may contain one or more of computing device 200, and an entire system may be made up of multiple computing devices 200 communicating with each other.

The processor 204 can execute instructions within the computing device 200, including instructions stored in the main memory 206. The processor may be implemented as chips that include separate and multiple analog and digital processors. The processor may provide, for example, for coordination of the other components of the device 200, such as control of user interfaces, applications run by device 200, and wireless communication by device 200.

Computing device 200 includes a processor 204, main memory 206, ROM 208, an input device 212, an output device such as a display 214, a communication interface 216, among other components including, for example, a receiver and a transceiver. The device 200 may also be provided with a storage device 210, such as a microdrive or other device, to provide additional storage. Each of the components are interconnected using various buses, and several of the components may be mounted on a common motherboard or in other manners as appropriate.

Computing device 200 may communicate wirelessly through communication interface 216, which may include digital signal processing circuitry where necessary. Communication interface 216 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver. In addition, short-range communication may occur, such as using a Bluetooth, WiFi, or other such transceiver (not shown). In addition, a GPS (Global Positioning system) receiver module may provide additional navigation- and location-related wireless data to device 200, which may be used as appropriate by applications running on device 200.

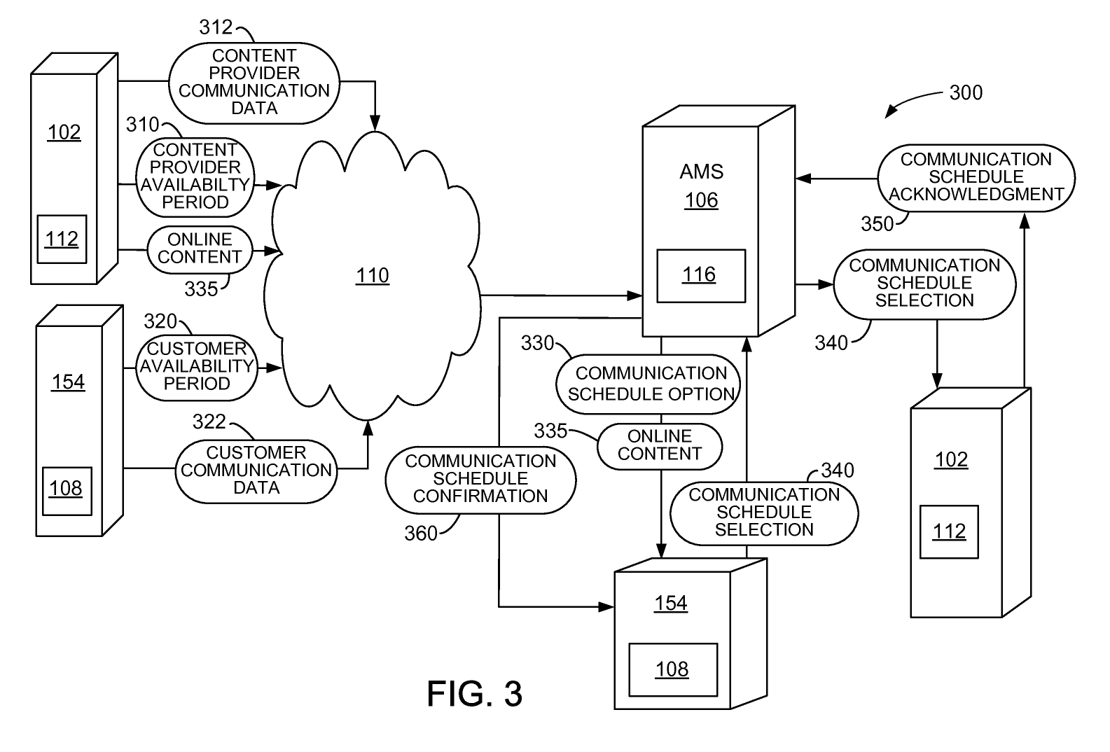

FIG. 3 is an example process flowchart 300 of scheduling a communication between a content provider 102 and a customer, such as customer 154 (shown in FIG. 1), using the computing device 200 (shown in FIG. 2) in the advertising environment 100 (shown in FIG. 1). Flowchart 300 illustrates content provider 102, via content provider data processing system 112, and customer 154, via customer computing device 108, interacting with a content management server, AMS 106, via a content management data processing system 116 to schedule communication between content provider 102 and customer 154.

In operation, content provider 102 uses content provider data processing system 112 to provide a content provider availability period 310 to AMS 106 via network 110. Content provider availability period 310 represents at least one time period when content provider 102 is available for a communication with a customer including, for example, customer 154. The communication may be conducted using a telephone or, alternately, a chat service such as a voice chat service. Content provider availability period 310 may include, for example, a list of time intervals when content provider 102 is available for communication. The time intervals may be of fixed lengths (e.g., blocks of fifteen minutes) or variable lengths. In some examples, the time intervals may reflect the typical communication duration associated with content provider 102. For example, if a typical telephone call with a content provider 102 is eight minutes, content provider availability period 310 may be provided in blocks of eight minutes. Content provider availability period 310 is associated with at least one online content 335 including, for example, at least one online advertisement. Online content 335 may be sent to AMS 106 via network 110 contemporaneously with content provider availability period 310. Alternately, online content 335 may be sent before or after content provider availability period 310. Additionally, content provider availability period 310 may be updated to reflect changing availability periods for content provider 102. Accordingly, content provider availability period 310 may be sent multiple times for a particular online content 335 wherein each new content provider availability period 310 replaces a prior version.

Content provider availability period 310 may additionally be obtained by AMS 106 if content provider 102 participates in a content provider scheduling service (not shown) offered by a system associated with AMS 106. If content provider 102 participates in the content provider scheduling service, content provider 102 provides communication information for a scheduling server or scheduling data source associated with content provider 310. The scheduling server or scheduling data source includes data associated with content provider availability 310 and may transmit schedule information to AMS 106 (or a system associated with AMS 106) upon request. In other words, content provider 102 can provide data to AMS 106 in a dynamic fashion by participating in the content provider scheduling service and associating at least one scheduling server with the content provider scheduling service.

Content provider 102 additionally uses content provider data processing system 112 to provide a content provider communication data 312 to AMS 106 via network 110. Content provider communication data 312 may include, for example, preferred times to contact content provider 102, contact information associated with content provider 102, call volumes associated with a plurality of time intervals, non-operational time intervals, and call durations associated with a plurality of time intervals. Non-operational time intervals represent time periods when content provider 102 is unavailable for communication. For example, a non-operational time interval may include the hours in which a content provider 102 is closed for business. Content provider communication data 312 may be beneficial in determining preferable times for communication with content provider 102.

Content provider communication data 312 may also include, for example, typical call durations and hold durations associated with communications. Call durations and hold durations may be obtained by using the content provider scheduling service. In other words, content provider 102 may track hold durations and call durations and store such information in a server in communication with the content provider scheduling service. In other examples, call durations and hold durations may be obtained by a system associated with AMS 106 tracking wait times to estimate an average wait time.

Content provider 102 may additionally perform multiple varieties of customer service. In one example, content provider 102 is an airline. Content provider 102 may include services for “New Reservations”, “Existing Reservations”, and “Loyalty Program Reservations.” Accordingly, content provider 102 may provide different content provider availability periods 310 and content provider communication data 312 for each period.

Customer 154 uses customer computing device 108 including, for example, a laptop computer, a mobile computing device, or a desktop computer, to provide a customer availability period 320 to AMS 106 via network 110. Customer availability period 320 represents at least one time period when customer 154 is available for communication with content provider 102. Customer availability period 320 may include, for example, a list of time intervals when customer 154 is available for communication. Customer availability period 320 may be received from a scheduling software including, for example, an online scheduling tool, a file or program at customer computing device 108, or scheduling services associated with customer 154 on, or otherwise available to, AMS 106. Along with customer availability period 320, customer 154 uses customer computing device 108 to provide customer communication data 322 to AMS 106 via network 110. Customer communication data 322 may include, for example, preferred times to contact customer 154, telephone contact identifiers including phone numbers, chat contact identifiers including user information for chatting, voice chat contact identifiers including user information for voice chatting, and preferred methods of contact with customer 154. In some examples, no customer availability periods 320 may be provided because customer 154 is not signed into scheduling software or data from such software is unavailable. In other examples, no customer availability periods 320 may be provided because customer 154 does not have any available time intervals indicated in their schedule. If no customer availability periods 320 are provided, determinations of communication schedule options 330 can be determined using content provider availability periods 310.

AMS 106 uses content provider availability period 310, customer availability period 320, content provider communication data 312, and customer communication data 322 to determine at least one communication schedule option 330 associated with online content 335. Communication schedule option 330 represents at least one time interval when communication may be made between customer 154 and content provider 102, considering the respective restrictions in the schedules of each. In cases where multiple communication schedule options 330 are determined, AMS 106 may additionally determine a preferred schedule option based upon at least one of a customer preference and a content provider preference. The customer preference and the content provider preference may be reflected in content provider communication data 312 and customer communication data 322. In cases where no customer availability periods 320 are received, communication schedule options 330 are determined using content provider availability periods 310. If no time intervals exist when communication may be made between customer 154 and content provider 102, considering the respective restrictions in the schedules of each, an indication will be provided to customer 154 that no options exist. Accordingly customer 154 may alternately change their schedule or attempt to schedule in a different time period.

Communication schedule option 330 is transmitted by AMS 106 to customer computing device 108 along with online content 335. In other words, online content 335 such as an online advertisement is presented with the communication schedule options 330 so that customer 154 can view time intervals when communication with the content provider 102 may be scheduled. Customer 154 selects a particular time interval in order to schedule such communication. If AMS 106 determines a preferred schedule option, AMS 106 may additionally transmit the preferred schedule option (not shown in FIG. 3) and display the preferred schedule option with an indication such as highlighting, textual indicators, and graphical indicators. AMS 106 additionally creates a callback extension (not shown in FIG. 3) associated with online content 335 to display communication schedule options 330. The call back extension is a customer module configured to receive customer interaction associated with communication schedule selection 340.

AMS 106 receives communication schedule selection 340 from customer computing device 108. Communication schedule selection 340 represents the selection of a time interval by customer 154 from communication schedule options 330. In other words, customer 154 interacts with online content 335 using, for example, the callback extension, to select a particular time interval to communicate with content provider 102. Communication schedule selection 340 is transmitted to AMS 106. Customer 154 makes communication schedule selection 340 by interacting with online content 335 presented to customer 154 including, for example, clicking on a particular time interval in a schedule.

AMS 106 transmits communication schedule selection 340 to content provider data processing system 112. This allows content provider 102 to schedule the communication and ultimately communicate with customer 154. The communication can additionally be facilitated using an automated system. The call or communication between customer 154 and content provider 102 may be automatically initiated using such an automated system at the time represented by the communication selection.

AMS 106 receives communication schedule acknowledgment 350 from content provider data processing system 112. Communication schedule acknowledgment 350 indicates that content provider 102 can complete the communication with customer 154 at the time indicated in communication schedule selection 340. Communication schedule acknowledgement 350 may be useful in examples where multiple customers 154 attempt to schedule in the same time period simultaneously. Therefore, allowing content provider 102 the opportunity to provide communication schedule acknowledgment 350 reduces risks associated with overscheduling.

AMS 106 transmits communication schedule confirmation 360 to customer computing device 108. Communication schedule confirmation 360 indicates that content provider 102 has provided communication schedule acknowledgment 350 and, more specifically, that the communication can occur as scheduled.

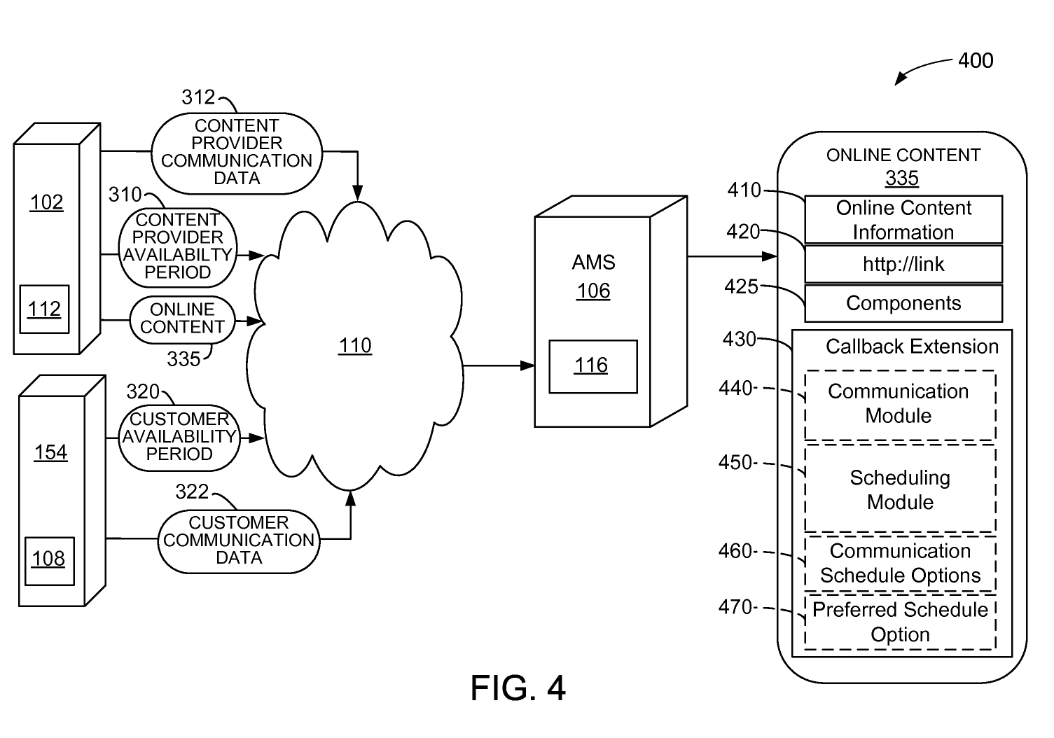

FIG. 4 is an example process flowchart 400 of providing an online content 335 configured to be used in scheduling a communication between a content provider 102 and a customer such as customer 154 (shown in FIG. 1), using computing device 200 (shown in FIG. 2) in advertising environment 100 (shown in FIG. 1). More specifically, process flowchart illustrates online content 335 including callback extension 430 which is configured to receive interaction by customer 154 to schedule communication between content provider 102 and customer 154.

As indicated in process flowchart 300, AMS 106 receives content provider availability period 310 and content provider communication data 312 from content provider 102 using content provider data processing system 112. AMS also receives, simultaneously or not simultaneously with content provider availability period 310, online content 335 wherein online content 335 is associated with content provider availability period 310. AMS 106 also receives customer availability period 320 and customer communication data 322 from customer 154 using customer computing device 108. AMS receives content provider availability period 310, content provider communication data 312, online content 335, customer availability period 320, and customer communication data 322 via network 110. AMS 106 determines, using the received data, communication schedule option 330 and transmits communication schedule option 330 with online content 335.

Communication schedule option 330 is transmitted with online content 335. In operation, online content 335 includes online content information 410. Online content information 410 includes, for example, text information associated with online content 335 such as a title of online content 335, graphical information associated with online content 335 such as a logo for online content 335, and audiovisual information associated with online content 335 such as animation or sounds associated with online content 335. Online content 335 additionally includes online content link 420 representing a link allowing customer 154 to navigate to a resource associated with online content 335 such as a webpage. Online content 335 further includes online content components 425. Online content components 425 include, for example, interactive elements allowing customer 154 to interact with online content 335. Online content components 425 may include forms, games, questions, surveys, and any other form of components capable of being served with online content 335.

Online content 335 is additionally served to customer computing device 108 with callback extension 430. Callback extension 430 includes communication module 440. Communication module 440 allows customer 154 to request instantaneous communication with content provider 102. In other words, communication module 440 allows customer 154 to make a selection which will initiate a communication with content provider 102. Communication module 440 may trigger an automatic communication between customer 154 and content provider 102 by using an automated communication system which creates a telephonic, chat, or voice chat connection between customer 154 and content provider 102. Such automatic communication may be facilitated using an automatic telephonic or chat system configured to create such a connection. Communication module 440 may additionally be configured to receive a request for a call from customer 154 which AMS 106 receives and transmits to content provider 102. In other words, content provider 102 will receive an alert, message, or other communication from AMS 106 indicating that customer 154 wishes to communicate. Content provider 102 may initiate contact with customer 154 using any appropriate systems. Communication module 440 may additionally be configured to display information related to contacting content provider 102 including, for example, current wait times for communication, average wait times for communication at all time periods, average wait times for communication at the present time period, and contact information for content provider 102.

Callback extension 430 also includes scheduling module 450. Scheduling module 450 is configured to allow customer 154 to view communication schedule options 460 and select communication schedule selection 340 (shown in FIG. 3). Scheduling module 450 may display communication schedule options 460 by themselves or in conjunction with schedule details of customer 154. For example, scheduling module 450 may display the all or part of a schedule associated with customer 154 and further display communication schedule options 460 in the context of that schedule. Alternately, scheduling module 450 may display just communication schedule options 460 by themselves. If, as described above, AMS determines a preferred schedule option, callback extension 430 will also include preferred schedule option 470 wherein preferred scheduled option 470 reflects a time period which AMS 106 determines to be preferable for customer 154 and content provider 102 based upon data including content provider availability period 310, content provider communication data 312, online content 335, customer availability period 320, and customer communication data 322. Customer 154 uses online content 335, and more specifically callback extension 430, to select a time period from communication schedule options 460 which is transmitted to AMS 106 as communication schedule selection 340.

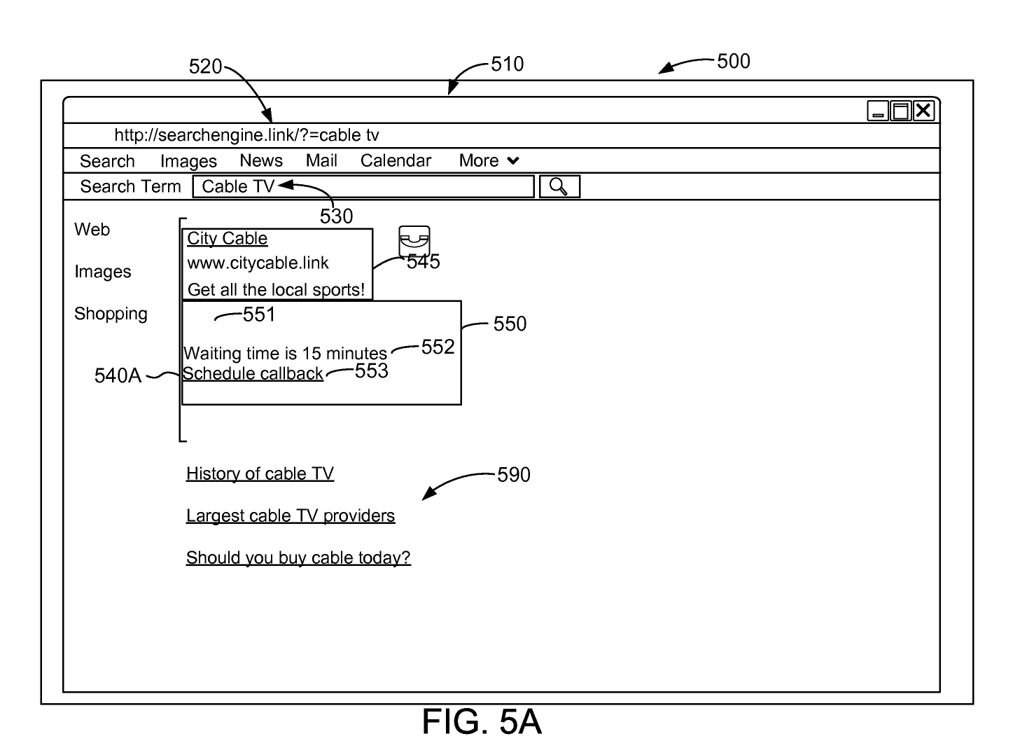

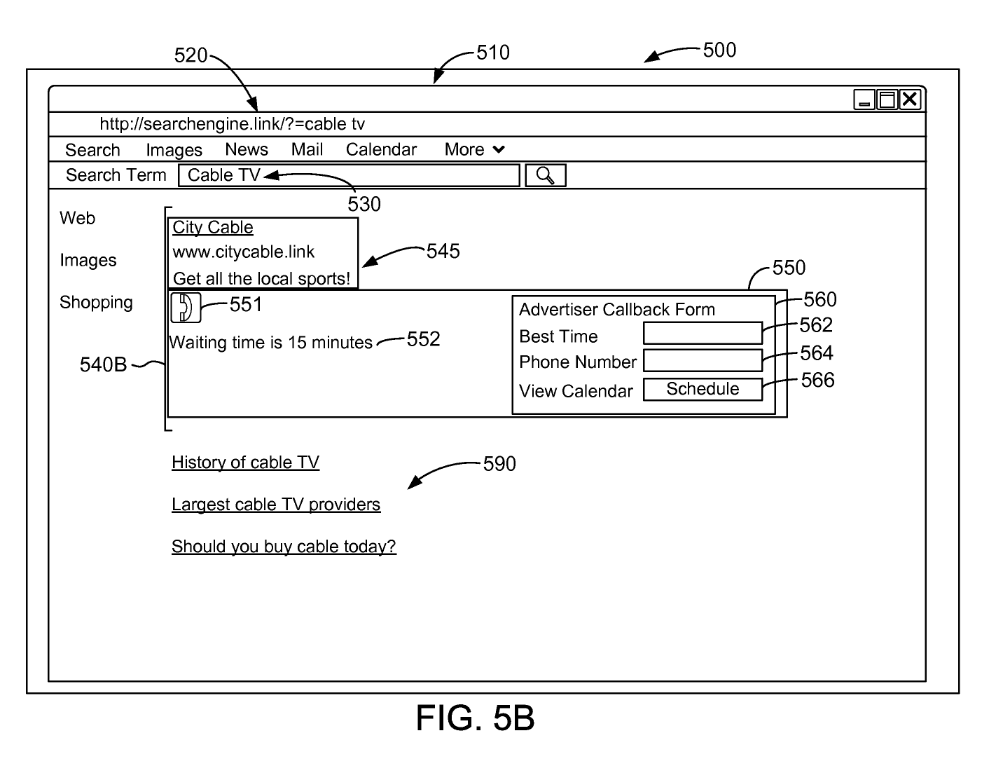

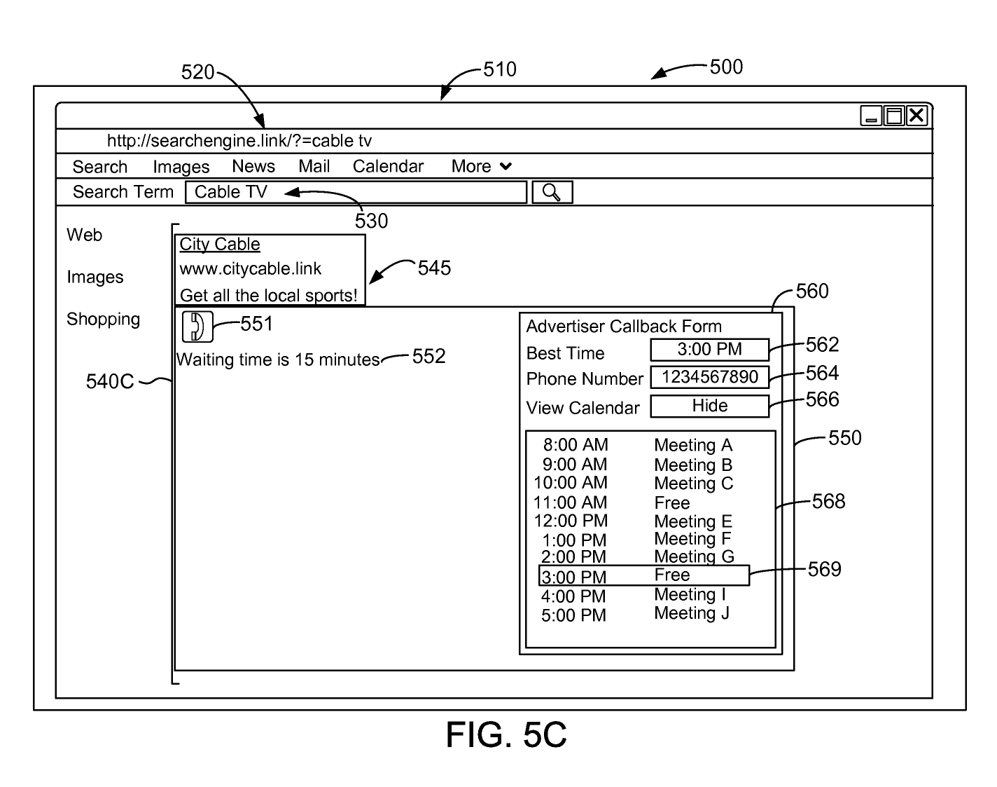

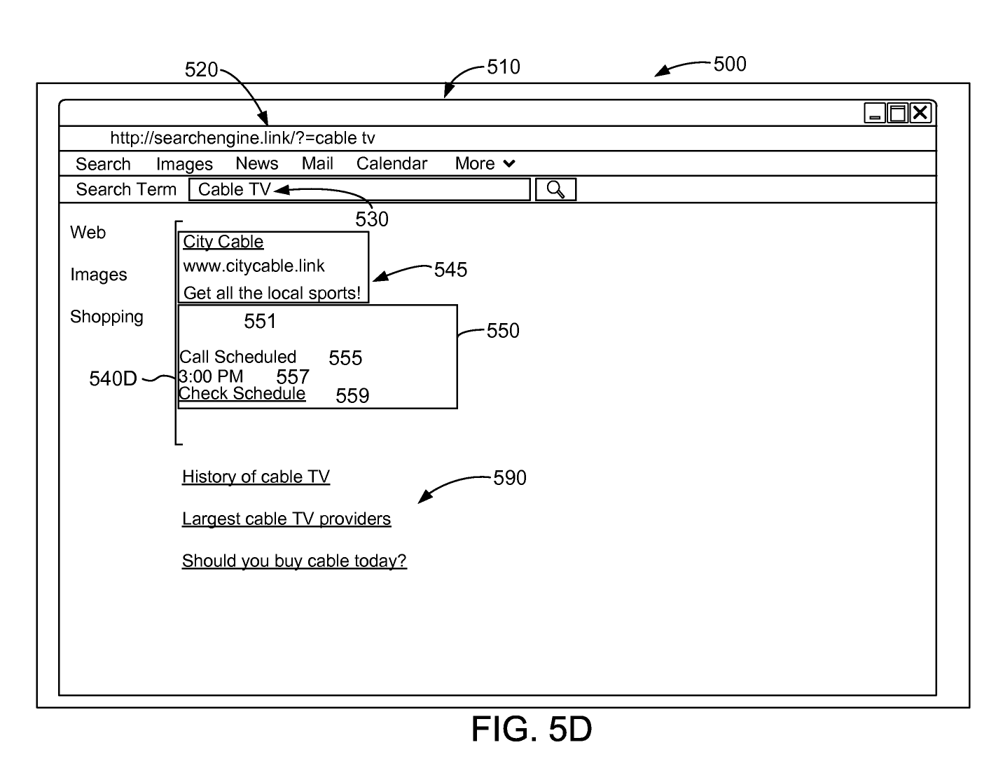

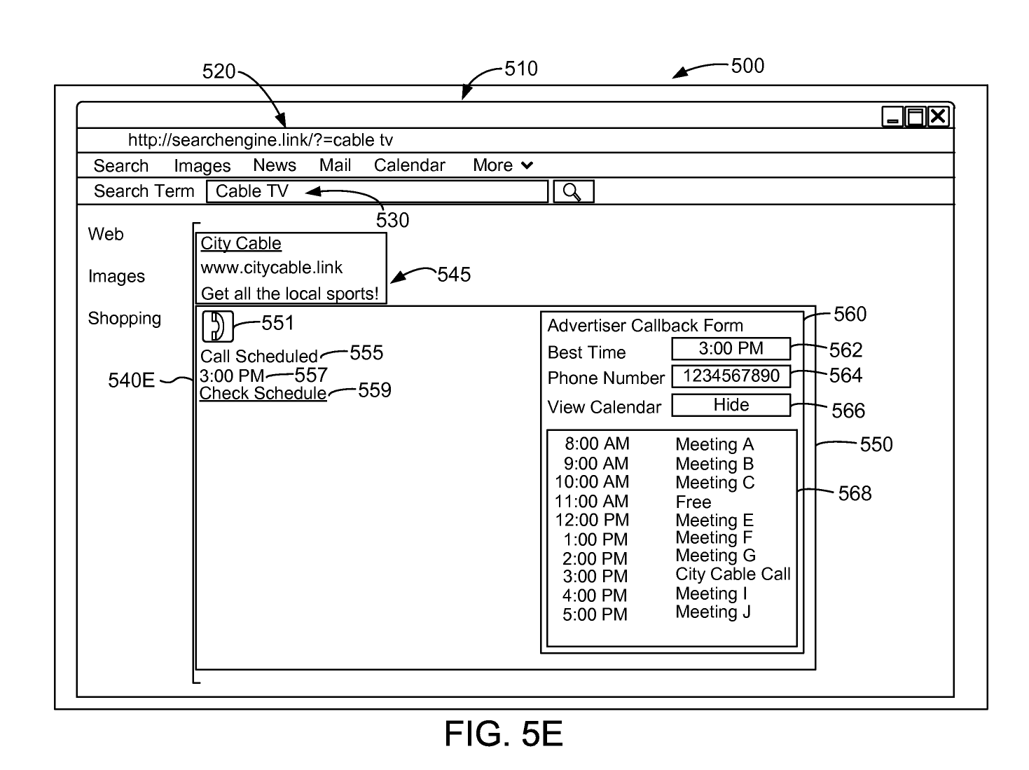

FIG. 5A is an example customer computing device 108 (shown in FIG. 1) displaying a first online content 540A configured to schedule a communication between content provider 102 and customer 154 (both shown in FIG. 1), using computing device 200 (shown in FIG. 2) in advertising environment 100 (shown in FIG. 1). First online content 540A represents online content 335 (shown in FIG. 4) provided by AMS 106 (shown in FIG. 4) to customer computing device 108 wherein online content 335 is generated and transmitted by AMS 106. First online content 540A is configured to allow interaction by customer 154 to schedule a communication between content provider 102 and customer 154.

FIG. 5A includes display 500 associated with customer computing device 108 displaying a web browser 510 showing online content available at web resource 520. In the example embodiment, web browser 510 has navigated to web resource 520 based upon a search using search term 530. Search term 530 is, in the example embodiment, “Cable TV”. In other words, customer 154 has searched for search content responsive to “Cable TV” to find out about offerings and services for cable television. Web browser 510 displays first online content 540A and search content 590 to display search content responsive to search term 530 of “Cable TV”. Search content 590 includes a plurality of links and information related to publication content, such as online publications, containing information pertaining to “Cable TV.”

First online content 540A includes online content details 545. Online content details 545 include, for example, text related to first online content 540A identifying an associated content provider 102, a link related to first online content 540A allowing customer 154 to navigate to a web resource associated with content provider 102, and text, graphic, and audiovisual information related to first online content 540A including, for example, logos, animations, videos, and interactive content. First online content 540A also includes callback extension 550. Callback extension 550 includes communication function 551. Communication function 551 allows customer 154 to request instantaneous communication with content provider 102. In other words, communication function 551 allows customer 154 to make a selection which will initiate a communication with content provider 102. Communication function 551 may trigger an automatic communication between customer 154 and content provider 102 by using an automated communication system which creates a telephonic, chat, or voice chat connection between customer 154 and content provider 102. Such automatic communication may be facilitated using an automatic telephonic or chat system configured to create such a connection. Communication function 551 may additionally be configured to receive a request for a call from customer 154 which AMS 106 receives and transmits to content provider 102. In other words, content provider 102 will receive an alert, message, or other communication from AMS 106 indicating that customer 154 wishes to communicate. Content provider 102 may initiate contact with customer 154 using any appropriate systems.

In operation, customer 154 may click the icon indicated as communication function 551 and alternately receive a call from content provider 102, receive a chat request from content provider 102, and be instantly connected to a phone call or chat with content provider 102 suing an automatic telephonic or chat system.

Callback extension 550 also includes communication information 552. Communication information 552 displays information related to communicating with content provider 102. In the example embodiment, communication information 552 represents a wait time for customer 154. In other words, if customer 154 uses communication function 551, the expected wait time is fifteen minutes.

Callback extension 550 further includes scheduling function 553. Scheduling function 553 allows customer 154 to select a time to communicate with content provider 102. In operation, if customer 154 determines that, based on communication information 552, communication is going to be impractical at the moment, customer 154 can select scheduling function to select a better time for communication.

FIG. 5B is an example customer computing device 108 (shown in FIG. 1) displaying a second online content 540B configured to schedule a communication between content provider 102 and customer 154 (both shown in FIG. 1), using computing device 200 (shown in FIG. 2) in advertising environment 100 (shown in FIG. 1). As in FIG. 5A, FIG. 5B represents a display 500 associated with customer computing device 108 displaying a web browser 510 showing online content available at web resource 520. Further, web browser 510 displays second online content 540B responsive to search term 530 along with search content 590.

More specifically, second online content 540B represents online content displayed after customer 154 selects scheduling function 553 (shown in FIG. 5A). In contrast to first online content 540A, second online content 540B includes scheduling module 560. Scheduling module 560, in the example embodiment, displays an advertiser callback form wherein customer 154 can specify a time and phone number for callback.

Scheduling module 560 includes time selection 562. Time selection 562 represents a time that may be selected by customer 154 for communication with content provider 102. In the example embodiment, customer 154 can select multiple time selections 562 by typing separate times or alternately using a graphical interface to make time selections 562. In alternate embodiments, time selection 562 may be pre-populated by AMS 106 after AMS 106 determines a time based upon content provider availability period 310 (shown in FIG. 4) and customer availability period 320 (shown in FIG. 4). Additionally, customer 154 may first determine time selection 562 after reviewing schedule planner module 566. In the example embodiment, customer uses schedule planner module 566, discussed below.

Scheduling module 560 also includes contact identifier 564. Contact identifier 564 is configured to allow customer 154 to provide contact information used to facilitate communication between customer 154 and content provider 102. In the example embodiment, contact identifier 564 can be a telephone number. In alternate embodiments, multiple telephone numbers may be provided and customer 154 may specify that a particular telephone number is preferred. In additional embodiments, customer 154 may specify a contact identifier 564 representing an identifier for a chat or voice chat service. In further embodiments, customer 154 may be signed into an online service (not shown) associated with AMS 106. Such an online service may contain user information related to customer 154 which may include values for contact identifier 564. Accordingly, when customer 154 is signed into the online service, the value of contact identifier 564 may be prepopulated using to the values stored in the online service.

FIG. 5C is an example customer computing device 108 (shown in FIG. 1) displaying a third online content 540C configured to schedule a communication between content provider 102 and customer 154 (both shown in FIG. 1), using computing device 200 (shown in FIG. 2) in advertising environment 100 (shown in FIG. 1). As in FIG. 5A and FIG. 5B, FIG. 5C represents a display 500 associated with customer computing device 108 displaying a web browser 510 showing online content available at web resource 520. Further, web browser 510 displays third online content 540C responsive to search term 530 along with search content 590.

More specifically, third online content 540C represents online content displayed after customer 154 selects schedule planner module 566. In contrast to second online content 540B, second online content 540B includes schedule 568. Schedule 568 represents a calendar associated with customer 154 showing times when customer 154 is available for communication with content provider 102. In the example embodiment, customer 154 is available at 11:00 AM and 3:00 PM. Schedule 568 further includes preferred schedule option 569. Preferred schedule option 569 reflects a time period which AMS 106 (shown in FIG. 4) determines to be preferable for customer 154 and content provider 102 based upon data including content provider availability period 310, content provider communication data 312, online content 335, customer availability period 320, and customer communication data 322 (all shown in FIG. 4). Schedule 568 may be populated based upon scheduling software stored at customer computing device 108, AMS 106, and an external scheduling server. Schedule 568 may use methods including web services and application programming interfaces (“APIs”) to obtain data for schedule 568. Due to availability indicated in schedule 568, time selection 562 is pre-populated with a value representing free-time for customer 154. In the example, time selection 562 is pre-populated with “3:00 PM” as that is a time indicated as free in schedule 568. Customer 154 may accept the pre-populated time selection 562 or replace it with a new time.

If schedule 568 indicates that no times are available for communication (e.g., due to the lack of free time on schedule 568), customer 154 will receive an indication that no options exist in the time period under review. Accordingly, customer 154 may alter their schedule 568 to accommodate more time periods or alternately review schedule 568 for a new time period (e.g., a different day.)

FIG. 5D is an example customer computing device 108 (shown in FIG. 1) displaying a fourth online content 540D configured to schedule a communication between content provider 102 and customer 154 (both shown in FIG. 1), using computing device 200 (shown in FIG. 2) in advertising environment 100 (shown in FIG. 1). As in FIG. 5A, FIG. 5B, and FIG. 5C, FIG. 5D represents a display 500 associated with customer computing device 108 displaying a web browser 510 showing online content available at web resource 520. Further, web browser 510 displays fourth online content 540D responsive to search term 530 along with search content 590.

More specifically, fourth online content 540D represents online content displayed after customer 154 selects time selections 562 (shown in FIG. 5B). In other words, fourth online content 540D shows online content displayed after customer 154 has scheduled a communication with content provider 102. Fourth online content 540D includes a call status indicator 555, call scheduling data 557, and call review function 559. Call status indicator 555 represents an indicator including a text indicator showing that communication between customer 154 and content provider 102 has been scheduled. Call scheduling data 557 includes information related to the scheduled communication including, for example, the time of the communication and contact identifiers associated with content provider 102. In the example embodiment, call scheduling data 557 shows that customer 154 has scheduled a call for 3:00 PM. Call review function 559 allows for a review of the schedule of customer 154 to verify the time of the communication and additionally cancel or reschedule the communication.

FIG. 5E is an example customer computing device 108 (shown in FIG. 1) displaying a fifth online content 540E configured to schedule a communication between content provider 102 and customer 154 (both shown in FIG. 1), using computing device 200 (shown in FIG. 2) in advertising environment 100 (shown in FIG. 1). As in FIG. 5A, FIG. 5B, FIG. 5C, and FIG. 5D, FIG. 5E represents a display 500 associated with customer computing device 108 displaying a web browser 510 showing online content available at web resource 520. Further, web browser 510 displays fifth online content 540E responsive to search term 530 along with search content 590.

More specifically, fifth online content 540E represents online content displayed after customer 154 selects call review function 559 (shown in FIG. 5D). Accordingly, fifth online content 540E displays scheduling module 560 including schedule 568. In the example embodiment, communication with content provider 102 (represented here as “City Cable”) is scheduled for 3:00 PM.

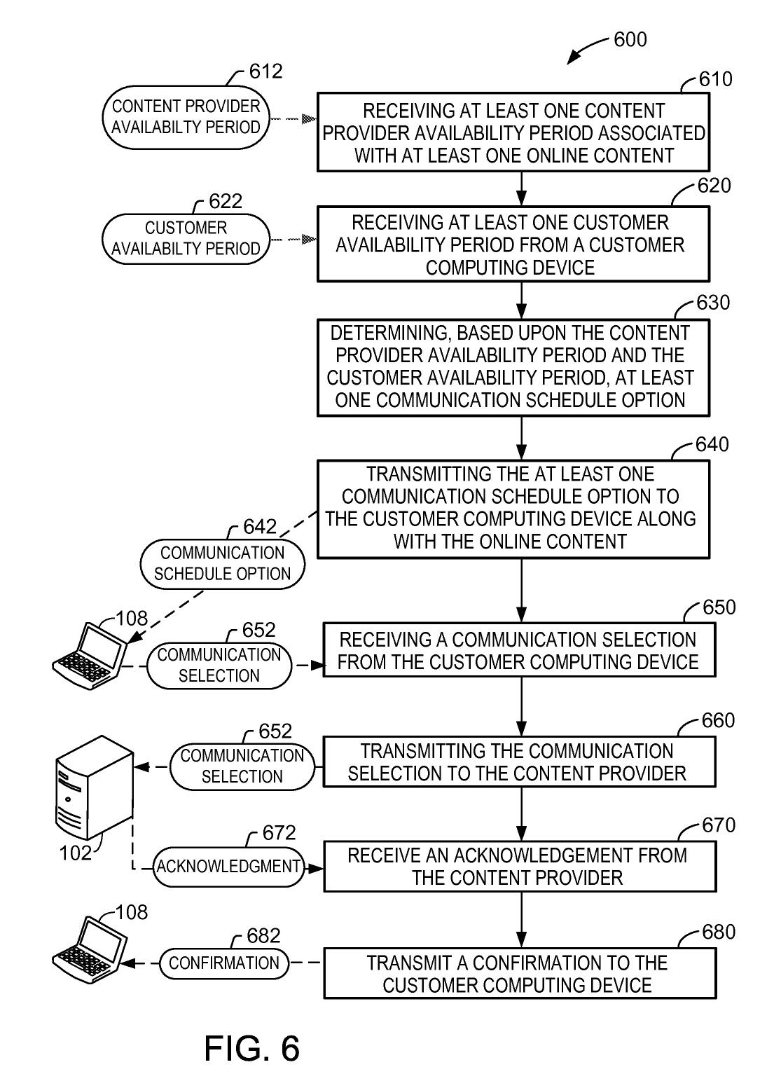

FIG. 6 is an example method 600 for scheduling a communication between content provider 102 and customer 154 using AMS 106 (shown in FIG. 1) in advertising environment 100 (shown in FIG. 1). AMS 106 receives 610 at least one content provider availability period 612 associated with at least one online content. Receiving 610 represents AMS 106 receiving content provider availability period 310 (shown in FIG. 3) associated with online content 335 (shown in FIG. 3) from content provider data processing system 112 (shown in FIG. 3) over network 110 (shown in FIG. 3).

AMS 106 also receives 620 at least one customer availability period 622 from a customer computing device. Receiving 620 represents AMS 106 receiving customer availability period 320 (shown in FIG. 3) from customer computing device 108 (shown in FIG. 3) over network 110.

AMS 106 additionally determines 630, based upon content provider availability period 612 and customer availability period 622, at least one communication schedule option. Determining 630 represents AMS 106 determining at least one communication schedule option 330 (shown in FIG. 3).

AMS 106 further transmits 640 at least one communication schedule option 642 to customer computing device 108 along with the online content. Transmitting 640 represents sending communication schedule option 330 along with online content 335 to customer computing device as indicated in FIG. 4 and FIG. SA-E. More specifically, transmitting 640 represents sending communication schedule option 330 using callback extension 430 (shown in FIG. 4).

AMS 106 also receives 650 communication selection 652 from customer computing device 108. Receiving 650 represents receiving communication schedule selection 340 (shown in FIG. 3) from customer computing device 108.

AMS 106 additionally transmits 660 communication selection 652 to content provider 102. Transmitting 660 represents sending communication schedule selection 340 to content provider 102 to be used in facilitating communication between content provider 102 and customer 154.

AMS 106 further receives 670 an acknowledgement 672 from the content provider 102. Receiving 670 represents AMS 106 receiving an indication from content provider 102 indicating that content provider 102 can facilitate, execute, or otherwise carry out a communication with customer 154 at the time indicated by communication schedule selection 340. In other words, receiving 670 allows content provider 102 to communicate that the communication will occur as scheduled.

AMS 106 also transmits 680 a confirmation 682 to the customer computing device 108. Transmitting 680 represents AMS 106 sending an indication to customer computing device 108 reflecting the fact that content provider 102 can facilitate, execute, or otherwise carry out a communication with customer 154 at the time indicated by communication schedule selection 340. In other words, transmitting 680 allows customer 154 to be informed that the communication will occur as scheduled.

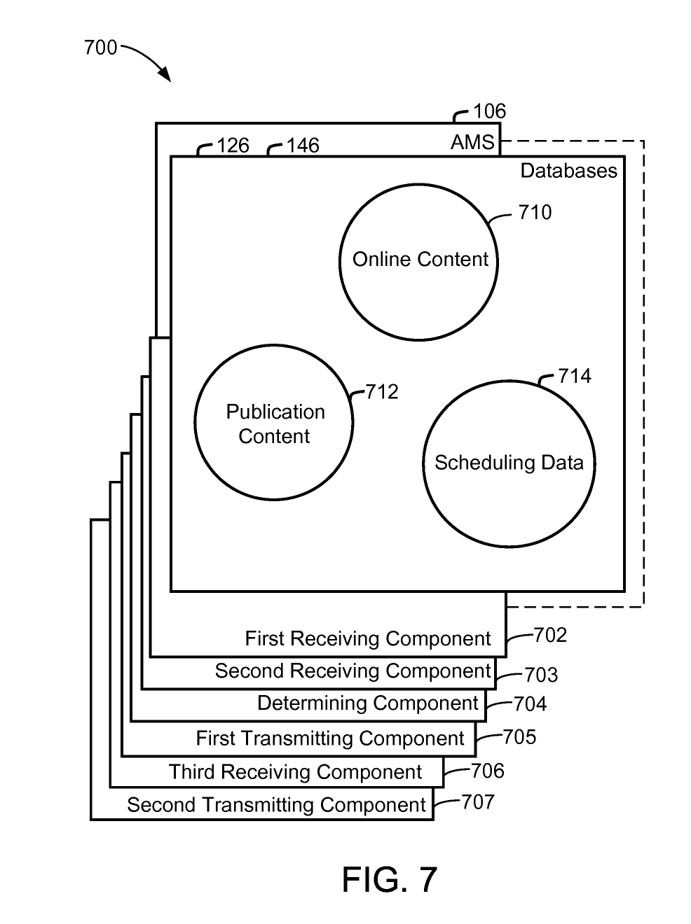

FIG. 7 is a diagram 700 of components of one or more example computing devices, for example computing device 200 (shown in FIG. 2), that may be used in environment 100 (shown in FIG. 1).

For example, one or more of computing devices 200 may form advertising management system (AMS) 106 or customer computing device 108 (both shown in FIG. 1). FIG. 7 further shows a configuration of databases 126 and 146 (shown in FIG. 1). Databases 126 and 146 are coupled to several separate components within AMS 106, content provider data processing system 112, and customer computing device 108, which perform specific tasks.

AMS 106 includes a first receiving component 702 for receiving least one content provider availability period 310 (shown in FIG. 3) associated with at least one online content 335 (shown in FIG. 3). AMS 106 also includes a second receiving component 703 for receiving at least one customer availability period 320 (shown in FIG. 3) from a customer computing device 108 (shown in FIG. 3). AMS 106 additionally includes a determining component 704 for determining, based upon content provider availability period 310 and customer availability period 320, at least one communication schedule option 330 (shown in FIG. 3). AMS 106 further includes a first transmitting component 705 for transmitting at least one communication schedule option 330 to customer computing device 108 along with online content 335. AMS 106 also includes a third receiving component 706 for receiving communication schedule selection 340 (shown in FIG. 3) from customer computing device 108. AMS additionally includes a second transmitting component 707 for transmitting communication schedule selection 340 to the content provider data processing system 112 (shown in FIG. 3).

In an exemplary embodiment, databases 126 and 146 are divided into a plurality of sections, including but not limited to, an online content section 710, a publication content section 712, and a scheduling data section 714. These sections within database 126 and 146 are interconnected to update and retrieve the information as required. Online content section 710 may include information including, for example, online content, online content layout options, online content callback extension layouts, and online content extension modules. Publication content section 712 may include information including, for example, identifiers for publication content which will be served with online content, identifiers for publication content which will be served without online content, and information regarding how to deliver dynamic online content with specific publication content. Scheduling data section 714 may include information including, for example, scheduling data associated with customer computing device 108, content provider data processing system 112, and preferred scheduling methods and options, generally.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It will be appreciated that the above embodiments that have been described in particular detail are merely example or possible embodiments, and that there are many other combinations, additions, or alternatives that may be included.

Also, the particular naming of the components, capitalization of terms, the attributes, data structures, or any other programming or structural aspect is not mandatory or significant, and the mechanisms that implement the subject matter described herein or its features may have different names, formats, or protocols. Further, the system may be implemented via a combination of hardware and software, as described, or entirely in hardware elements. Also, the particular division of functionality between the various system components described herein is merely for the purposes of example only, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations may be used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or “providing” or the like, refer to the action and processes of a computer system, or similar electronic computing device, that manipulates and transforms data represented as physical (electronic) quantities within the computer system memories or registers or other such information storage, transmission or display devices.

Based on the foregoing specification, the above-discussed embodiments may be implemented using computer programming or engineering techniques including computer software, firmware, hardware or any combination or subset thereof. Any such resulting program, having computer-readable and/or computer-executable instructions, may be embodied or provided within one or more computer-readable media, thereby making a computer program product, i.e., an article of manufacture. The computer readable media may be, for instance, a fixed (hard) drive, diskette, optical disk, magnetic tape, semiconductor memory such as read-only memory (ROM) or flash memory, etc., or any transmitting/receiving medium such as the Internet or other communication network or link. The article of manufacture containing the computer code may be made and/or used by executing the instructions directly from one medium, by copying the code from one medium to another medium, or by transmitting the code over a network.

While the disclosure has been described in terms of various specific embodiments, it will be recognized that the disclosure can be practiced with modification within the spirit and scope of the claims.

What is claimed is:

1. A computer-implemented method for scheduling a communication between a content provider and a customer, the method implemented using an online content server coupled to a memory device, the method comprising:
receiving, at the online content server, at least one content provider availability period associated with at least one online content for the content provider;
receiving, at the online content server, at least one customer availability period for the customer from a customer computing device;
determining, based upon the content provider availability period and the customer availability period, at least one communication schedule option;
transmitting the at least one communication schedule option to the customer computing device along with the online content;
receiving a communication selection from the customer computing device; and
transmitting the communication selection to the content provider.

2. The method of claim 1, further comprising:
receiving an acknowledgement from the content provider; and
transmitting a confirmation to the customer computing device.

3. The method of claim 1, wherein receiving the at least one content provider availability period further comprises receiving at least one of:
call volumes associated with a plurality of time intervals for the content provider;
non-operational time intervals for the content provider; and
call durations associated with a plurality of time intervals for the content provider.

4. The method of claim 1, wherein receiving the at least one content provider availability period further comprises receiving a list of time intervals when the content provider is available for communication.

5. The method of claim 1, further comprising receiving a contact identifier for the customer wherein the contact identifier includes at least one telephone number.

6. The method of claim 1, wherein receiving the customer availability period further comprises receiving a schedule from the customer from a scheduling software stored on at least one of:
the customer computing device;
the online content server; and
a scheduling server.

7. The method of claim 1, further comprising automatically initiating a communication between the customer and the content provider during the time period associated with the communication selection using an automated phone system.

8. The method of claim 1, further comprising:
determining, from the at least one communication schedule option, a preferred schedule option based upon at least one of a customer preference and a content provider preference; and
transmitting the at least one communication schedule option to the customer computing device wherein the preferred schedule option is displayed as a preferred option.

9. The method of claim 1, wherein receiving a communication selection from the customer computing device further comprises:
receiving a customer interaction from the customer associated with the online content presented to the customer.

10. The method of claim 1, wherein transmitting the at least one communication schedule option to the customer computing device along with the online content further comprises:
creating a callback extension associated with the online content, wherein the callback extension represents a customer module configured to receive customer interaction associated with the communication selection; and
displaying the callback extension with the online content.

11. An online content server for scheduling a communication between a content provider and a customer, the online content server comprising a memory device for storing data, and a processor in communication with the memory device, said processor programmed to:
receive a content provider availability period associated with an online content for the content provider;
receive a customer availability period from a customer computing device for the customer;
determine, based upon the content provider availability period and the customer availability period, at least one communication schedule option;
transmit the at least one communication schedule option to the customer computing device along with the online content;
receive a communication selection from the customer computing device; and
transmit the communication selection to the content provider.

12. The online content server of claim 11, wherein the processor is further programmed to:
receive an acknowledgement from the content provider; and
transmit a confirmation to the customer computing device.

13. The online content server of claim 11, wherein the processor is further programmed to receive at least one of:
call volumes associated with a plurality of time intervals for the content provider;
non-operational time intervals for the content provider; and
call durations associated with a plurality of time intervals for the content provider.

14. The online content server of claim 11, wherein the processor is further programmed to receive a list of time intervals when the content provider is available for communication.

15. The online content server of claim 11, wherein the processor is further programmed to receive a contact identifier for the customer wherein the contact identifier includes at least one telephone number.

16. The online content server of claim 11, wherein the processor is further programmed to receive a schedule from the customer from a scheduling software stored on at least one of:
the customer computing device;
the online content server; and
a scheduling server.

17. The online content server of claim 11, wherein the processor is further programmed to automatically initiate a communication between the customer and the content provider during the time period associated with the communication selection using an automated phone system.

18. The online content server of claim 11, wherein the processor is further programmed to:
determine, from the at least one communication schedule option, a preferred schedule option based upon at least one of a customer preference and a content provider preference; and
transmit the at least one communication schedule option to the customer computing device wherein the preferred schedule option is displayed as a preferred option.

19. The online content server of claim 11, wherein the processor is further programmed to receive a customer interaction from the customer associated with the online content presented to the customer.

20. The online content server of claim 11, wherein the processor is further programmed to:
create a callback extension associated with the online content, wherein the callback extension represents a customer module configured to receive customer interaction associated with the communication selection; and
display the callback extension with the online content.

21. A computer-readable storage device, having processor-executable instructions embodied thereon, for scheduling a communication between a content provider and a customer, wherein the computing device includes at least one processor and a memory device coupled to the processor, wherein, when executed by the computing device, the processor-executable instructions cause the computing device to:
receive, at the processor, at least one content provider availability period associated with at least one online content for the content provider;
receive, at the processor, at least one customer availability period from a customer computing device for the customer;
determine, based upon the content provider availability period and the customer availability period, at least one communication schedule option;
transmit the at least one communication schedule option to the customer computing device along with the online content;
receive a communication selection from the customer computing device; and
transmit the communication selection to the content provider.

22. The computer-readable storage device of claim 21, wherein the processor-executable instructions cause the computing device to:
receive an acknowledgement from the content provider; and
transmit a confirmation to the customer computing device.
